(19) United States
(12) Patent Application Publication
(10) Pub. No.: US 2009/0244780 A1
(43) Pub. Date: Oct. 1, 2009

(54) Magnetic Recording Medium and Recording/Reproducing Apparatus Therefor

(75) Inventors: Takashi Yoshida, Omitama (JP); Katsuhiko Kimura, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/411,554

(22) Filed: Mar. 26, 2009

(30) Foreign Application Priority Data
Mar. 26, 2008 (JP) 2008-079851

(51) Int. Cl. G11B 5/60

(52) U.S. Cl. 360/234.3; G9B/5.229

(57) ABSTRACT

A magnetic recording medium on which a plurality of concentric recording tracks is formed, the recording tracks including a plurality of closed shaped magnetic parts formed to be symmetrical with respect to two orthogonal axes in shape, the magnetic recording medium being rotated by a recording and reproducing apparatus provided with a slider including a recording and reproducing head to record or reproduce a magnetic recording, wherein when the recording and reproducing head which is moved with movement of a slider to record data on or reproduce data from the recording tracks is inclined by a predetermined angle with respect to a tangent line of concentric circles of the recording tracks, the slider moving in a radial direction of the concentric circles of the recording tracks, one of the two orthogonal axes of the magnetic parts is perpendicular to the recording and reproducing head.

### CROSS REFERENCE TO RELATED APPLICATIONS

This application claims the foreign priority benefit under 35 U.S.C. §119 of Japanese Patent Application No. 2008-079851 filed on Mar. 26, 2008, the disclosure of which is incorporated herein by reference.

### BACKGROUND OF THE INVENTION

1. Field of the Invention

The present invention relates to a magnetic recording medium whose recording capacity is increased, and a recording and reproducing apparatus which pulls out a magnetic recording medium stored in a cartridge, and records data thereon or reproduces data therefrom.

2. Description of the Related Art

The amount of information processed by information related apparatuses has been significantly increased with the development of a communication environment and electronics. Performance and processing capability of information related apparatuses, such as a personal computer, has also been increasing dramatically to cope with such a development of the environment. One of important problems to be solved to cope with the increasing amount of information is to increase the capacity of recording media that accumulate information.

To solve the problem, Japanese Patent Publication No. 2003-157502 discloses a technique which forms recording tracks in a perpendicular magnetic recording medium in which magnetic areas are patterned by cyclically arranging recording cells that are separated by non-recording areas. Japanese Patent Publication No. 2003-157502 also discloses a technique which makes the thermal conductivity of the non-magnetic areas to be lower than that of the recording cells to keep the temperature of the recording cells to be constant, thereby to stably record data by magnetic field application. These techniques realize a magnetic recording medium which has a high recording density and prevents records from being destroyed.

In addition to the techniques described above, Japanese Patent Publication No. 2006-277895 discloses a thermally assisted magnetic recording method for a perpendicular magnetic recording medium which employs a method of heating magnetic films by irradiating a leaser beam on a magnetic recording medium from a side opposite to the magnetic recording surface of the magnetic recording medium, or a method of heating magnetic films by a near field light, a heater, electromagnetic wave, or the like on the magnetic recording surface.

In the technique disclosed in Japanese Patent Publication No. 2003-157502, in the magnetic recording medium in which magnetic areas are patterned, each elliptical shaped recording cell which forms a magnetic area is arranged in a constant interval on concentric recording tracks in such a manner that the miner axis of the recording cell is positioned in a circumferential direction of the recording tracks and the major axis of the recording cell is positioned in a radial direction of the recording tracks.

A slider which includes a recording and reproducing head and is provided to a recording and reproducing apparatus is generally connected, via a suspension extending in the normal direction of rotation of the magnetic recording medium, to a rotational actuator which rotates about a rotational axis positioned away from the rotational axis of the concentric recording tracks.

Thus, inclination of the slider with respect to the normal line of the concentric recording tracks is varied depending on a position in the radial direction of the concentric circles. For example, it is assumed here that the suspension is straight rod-shaped, connected to a shaft center of the rotational actuator at an end thereof, and is provided with a slider at the other end thereof. In this configuration, the inclination of the slider becomes 0 when the straight line of the suspension coincides with the tangent line of the recording track which the recording and reproducing head records data on or reproduces data from. If the slider is moved in an inner peripheral direction or outer peripheral direction from the position, the inclination of the slider becomes larger as the amount of movement of the slider increases.

The inclination of the slider affects the area of the disk-shaped magnetic recording medium which the recording and reproducing head can record data on or reproduce data from. More specifically, if the inclination of the slider is smaller, the area becomes larger, and if the inclination of the slider is larger, the area becomes smaller.

To ensure the area on which data can be stably recorded on or reproduced from, the recording and reproducing head which records data on or reproduces data from the magnetic recording medium includes a slider set in such a manner that the inclination of the slider with respect to the recording track is within a predetermined yaw angle range. However, this configuration has a disadvantage that the inclination of magnetic areas and that of a writing element, reading element, and heating element of the recording and reproducing head may not match, and thus the magnetic flux may not be efficiently caught.

Here, the yaw angle with respect to a recording track means the inclination of the head, which reproduces data recorded on the magnetic recording medium, with respect to the tangent line of the concentric circle of a recording track. A cause of the above problem is that if, for example, the major axis of an ellipse shaped recording cell (magnetic part) is arranged in the direction of the normal line of the concentric circle, some part of the magnetic part comes close to the head in the major axis direction, but some part of the magnetic part is far from the head in the major axis direction since the head is inclined in the predetermined yaw angle (see Japanese Patent Publication No. 2003-157502).

In the technique disclosed in Japanese Patent Publication No. 2006-277895 in which the thermal conductivity of the non-magnetic areas are made to be lower than that of the recording cells so as to keep the temperature of the recording cells to be constant, thereby to stably record data by magnetic field application, it has been difficult to select a material for making a difference between the thermal conductivity of the non-magnetic parts which are adjacent to the magnetic parts and that of the recording cell, which is the magnetic part.

An object of the present invention is to provide a magnetic recording medium on which fine magnetic areas inclined corresponding to the inclination of a slider are patterned for increasing a storage capacity, and a recording and reproducing apparatus which pulls out the magnetic recording medium from a cartridge storing a plurality of the magnetic recording media and records data thereon or reproduces data therefrom.

A first aspect of the present invention provides a magnetic recording medium which is rotated by a recording and reproducing apparatus including a slider which is provided with a recording and reproducing head to record or reproduce a magnetic recording, including: a plurality of recording tracks which is formed concentrically; and a plurality of closed shaped magnetic parts which is formed in a predetermined distance on the recording tracks and is formed to be symmetrical with respect to two orthogonal axes in shape. The shape of the closed shaped magnetic parts is formed by connecting convex curved lines, convex curved lines and straight lines, or straight lines. If the shape of the closed shaped magnetic parts is formed by connecting the convex curved lines and straight lines, or connecting the straight lines, internal angles between the connected lines are from 90 degree to less than 180 degree. If the recording and reproducing head which is moved with movement of the slider to record data on or reproduce data from the recording tracks is inclined by a predetermined angle with respect to a tangent line of concentric circles of the recording tracks, the slider being levitated with an aerodynamic force by a predetermined distance from the recording tracks and moving in a radial direction of the concentric circles of the recording tracks, the magnetic parts are formed in such a manner that one of the two orthogonal axes of the magnetic parts is perpendicular to the recording and reproducing head.

A second aspect of the present invention provides a recording and reproducing apparatus which rotates a magnetic recording medium on which a plurality of recording tracks is formed concentrically, the recording tracks including a plurality of fine magnetic parts which are formed to be symmetrical with respect to an axis in shape. The recording and reproducing apparatus includes: a slider which is levitated with an aerodynamic force by a predetermined distance from the recording tracks and moves in a radial direction of concentric circles of the recording tracks; a recording and reproducing head which is provided to the slider and records or reproduces magnetic recording on the magnetic parts formed on the recording tracks; a tray for storing a flexible sheet like magnetic recording medium; a cartridge for storing a plurality of the trays; a moving base for moving the cartridge up and down; a tray pull-out mechanism for pulling out the tray so as to transfer the magnetic recording medium to a recording and reproducing part; a magnetic recording and reproducing part moving base which is disposed below the tray pull out mechanism and moves a magnetic recording and reproducing part which records data on or reproduces data from the magnetic recording medium up and down; and a clamper which is provided above the tray pull out mechanism and fixes the magnetic recording medium to a rotational part of the magnetic recording and reproducing part, the clamper including a float stabilizing disk of which radius is substantially equal to that of the magnetic recording medium, wherein the rotational part passes through the tray, and the magnetic recording medium is fixed to the rotational part by the clamper when the tray is pulled out from the cartridge.

Other features and advantages of the present invention will become more apparent from the following detailed descriptions of the invention when taken in conjunction with the accompanying drawings.

### BRIEF DESCRIPTION OF THE DRAWINGS

FIG. 1 shows a magnetic recording medium according to a first embodiment of the present invention which is set in a recording and reproducing apparatus, and is a partial enlarged plain view which schematically shows the positional relations among a plurality of recording tracks formed on the magnetic recording medium, a magnetic part formed in the recording track, and a slider including a magnetic head.

FIG. 2 shows the magnetic recording medium according to the first embodiment which is set in the recording and reproducing apparatus, and is an enlarged side cross sectional view showing the relationship between the magnetic recording medium and a slider including a magnetic head.

FIG. 3 shows a magnetic recording medium according to a second embodiment of the present invention which is set in the recording and reproducing apparatus, and is a side cross sectional view showing the relationships between the magnetic recording medium and a slider including a magnetic head.

FIG. 4 shows a magnetic recording medium according to a third embodiment of the present invention which is set in the recording and reproducing apparatus, and is an enlarged side cross sectional side view showing the relationship between the magnetic recording medium and a slider including a magnetic head.

FIG. 5 is a side view of a disk changer of a first example of a fourth embodiment of the present invention showing the entire configuration of the disk changer including a cartridge moving part for moving a cartridge up and down, and a recording and reproducing apparatus for recording data on or reproducing data from the magnetic recording medium in a state where the tray is pulled out from the cartridge and the cover is peeled.

FIG. 6A shows a configuration of the tray according to the first example of the fourth embodiment for storing a disciform magnetic recording medium.

FIG. 6B shows another configuration of the tray in which a hooking hole is arranged in a different position.

FIG. 7 is a plain view showing a configuration of a separator which is provided to the cartridge of the first example of the fourth embodiment.

FIG. 8 is a plain view of the recording and reproducing apparatus shown in FIG. 5 seen downward from the clamper.

FIG. 9 is the side view of a disk changer of the first example of the fourth embodiment in a state where the thin magnetic recording medium shown in FIG. 5 is fixed to a recording and reproducing part.

FIG. 10 shows a second example of the recording and reproducing apparatus according to the fourth embodiment in which a magnetic recording medium is set in the recording and reproducing apparatus, and is an enlarged side cross sectional view showing the relationship of the magnetic recording medium and a slider including a magnetic head.

FIG. 11 shows a third example of the recording and reproducing apparatus according to the fourth embodiment in which a magnetic recording medium is set in the recording and reproducing apparatus, and is an enlarged side cross sectional view showing the relationship of the magnetic recording medium and a slider including a magnetic head.

FIG. 12 is a side view of a disk changer of a fourth example of the fourth embodiment.

FIG. 13 is a plain view of the recording and reproducing apparatus shown in FIG. 12 seen downward from the clamper.

FIG. 14 is a side view of the disk changer of the fourth example of the fourth embodiment in a state where the thin magnetic recording medium shown in FIG. 12 is fixed to a recording and reproducing part.

### DETAILED DESCRIPTION OF EMBODIMENTS

### First Embodiment

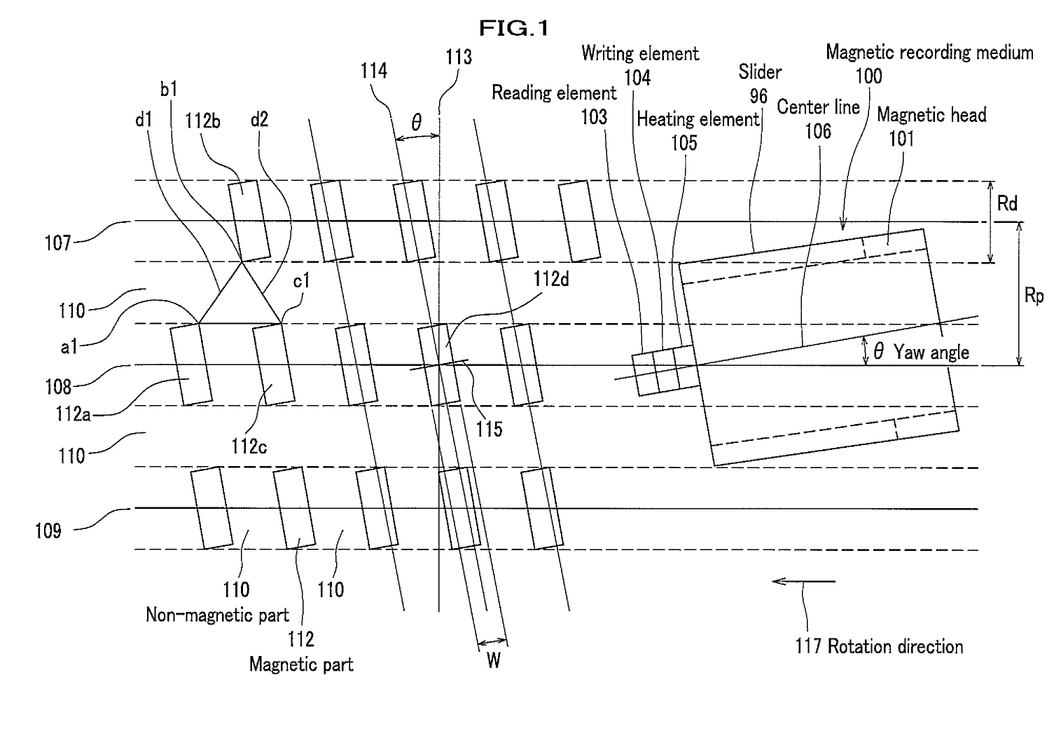

A first embodiment of the present invention is described in detail below with reference to the accompanying drawings. The first embodiment is related to a magnetic recording medium, and FIG. 1 shows a magnetic recording medium which is set in a recording and reproducing apparatus. FIG. 1 is a partial enlarged plain view which schematically shows the positional relations among a plurality of recording tracks formed on the magnetic recording medium, magnetic parts formed in the recording tracks, and a slider including a magnetic head. Lower side of FIG. 1 is the side closer to the center position of the concentric circles of the magnetic recording medium, and center lines 107, 108, 109 of the recording tracks, which are described later, are actually arcs of the concentric circles of which upper sides in FIG. 1 are convex. Specifically, the center line 107 is an outer side arc of the concentric circle and the center line 109 is an inner side arc of the concentric circle.

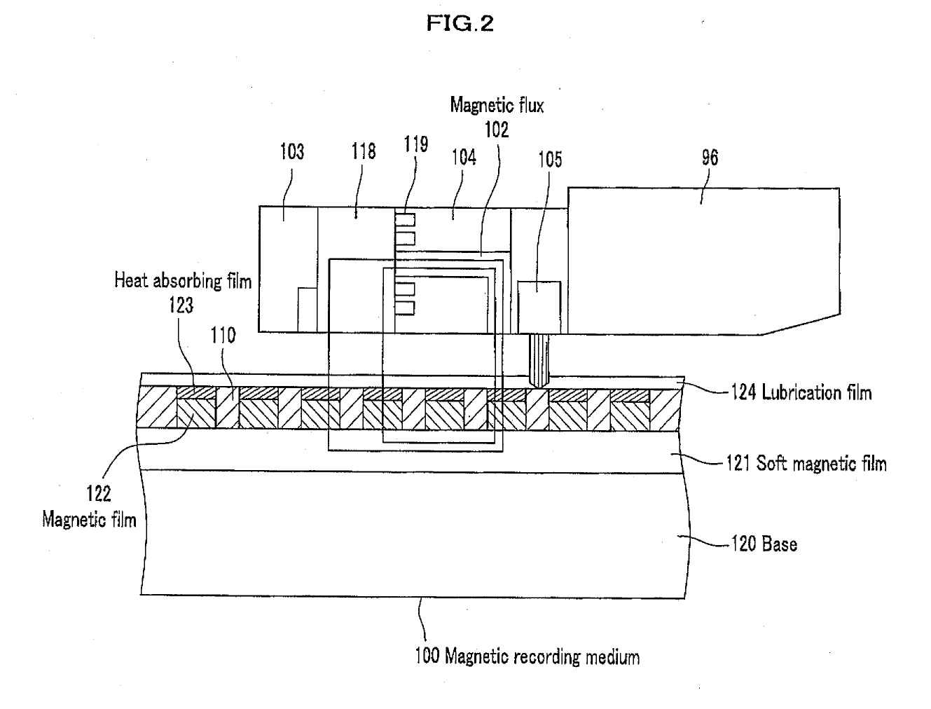

By making a gas flow between a slider 96 and a magnetic recording medium 100, which is described later, the slider 96 is levitated by the aero dynamic force from the surface of the magnetic recording medium 100 with a small space therebetween (see FIG. 2). As shown in FIG. 1, the slider 96 includes a magnetic head 101 (recording and reproducing head) for recording data on or reproducing data from the magnetic recording medium 100, a writing element 104 for recording information, a reading element 103 for reproducing information, and a heating element 105 for heating the magnetic part 112.

The slider 96 is configured in such a manner that a center line 106 passing the magnetic head 101 is inclined in a counterclockwise direction with respect to the tangent line of the center line 108 (concentric circle) of the recording track by a predetermined angle. The inclined angle is a yaw angle θ.

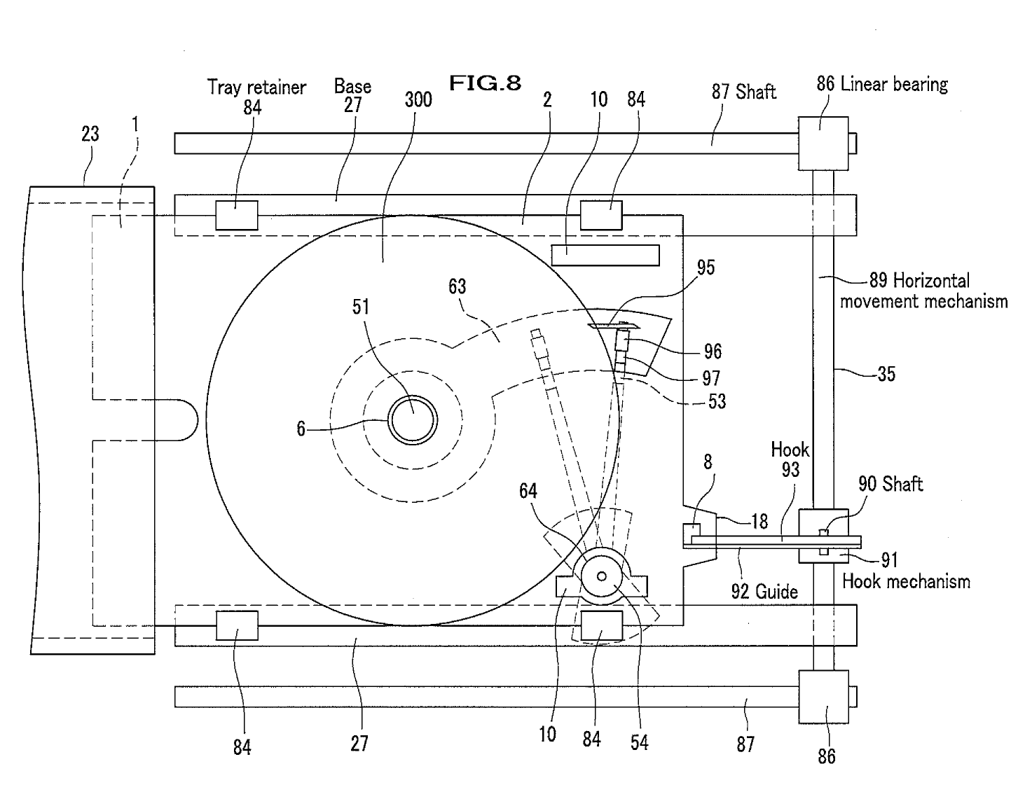

As shown in FIG. 8, the slider 96 is generally connected to a rotation actuator 54 rotating about a rotational axis that is positioned away from a clump part 51, which is the rotational axis of the concentric recording tracks, via a suspension 97 which extends in the normal direction of rotation of the rotation actuator 54. As the rotation actuator 54 rotates, the slider 96 is moved in the radial direction of the concentric circle of the magnetic recording medium 100 (300).

Thus, the yaw angle θ of the slider 96 with respect to the tangent line of the concentric circle of the recording track is changed depending on a position (the center lines 107, 108, 109 in FIG. 1) in the radial direction of the concentric circle.

To be more specific, in FIG. 1, angles of the yaw angle θ are different between when the magnetic head 101 records data on or reproduces data from the recording track of the center line 107 and when the magnetic head 101 records data on or reproduces data from the recording tracks of the center lines 108 and 109.

The writing element 104, the reading element 103 and the heating element 105 are formed on an end of the slider 96 in such a manner that these elements are stacked on one another by a film deposition technique or the like, and are inclined by the yaw angle θ which is the same as that of the slider 96. A GMR element, TMR element, or the like can be used for the reading element 103. A component which is made by wiring a coil around a magnetic pole including a gap and uses a leakage magnetic flux is used for the writing element 104. The heating element 105 uses a near field light, electromagnetic wave, or the like.

The magnetic recording medium 100 includes the fine area magnetic parts 112 which record information and non-magnetic parts 110 which are composed of a nonmagnetic material on which information is not recorded. The magnetic recording medium 100 is placed in the recording and reproducing apparatus, and is rotated in the direction indicated by a rotation direction 117. The magnetic parts 112 are formed in a constant distance in such a manner that the center of the magnetic parts 112 is located on the center lines 107, 108, 109 of the plurality of recording tracks that is provided concentrically on the magnetic recording medium 100. As explained before, the center lines 107, 108, 109 of the recording tracks are represented as straight lines in FIG. 1, however, the magnetic recording medium 100 is actually disciform, and the recording tracks are concentric circular arc shapes.

The magnetic part 112 is formed in a rectangular shape which has a major axis and a minor axis in the plain view of FIG. 1, and the width of the rectangular shape is the width W of the minor axis as shown in a magnetic part 112d on the center line 108 of the recording track in FIG. 1. The magnetic part 112 is axis symmetry with respect to the major axis 114 and the minor axis 115 that are perpendicular to each other. The major axis 114 is inclined in a counterclockwise direction by the yaw angle θ with respect to a center line 113 which is the normal line of the concentric recording track passing on the cross point of the minor axis 115 and the major axis 114 of the magnetic part 112.

The shape of the magnetic part 112 is symmetry with respect to the two perpendicular axes, and is formed by connecting convex curved lines, convex curved lines and straight lines, or straight lines. If the shape of the magnetic part 112 is formed by connecting convex curved lines and straight lines, or straight lines, the shape of the magnetic part 112 may be any closed shape as long as the internal angles between the connected lines are from 90 degree to less than 180 degree. For example, an outline of the magnetic part 112 may be an ellipse, oval, rounded rectangle or quadrangle (square, rectangle), and is not limited to the rectangle described in the embodiment. Such a shape of the magnetic part 112 makes it possible to prevent the distance between the magnetic head 101 and the magnetic part 112 from being irregularly changed in the major axis 114 direction of the magnetic part 112.

Next, the relations among a plurality of the magnetic parts 112, . . . , 112 are explained with reference to magnetic parts 112a, 112b and 112c in FIG. 1.

The adjacent magnetic parts 112a, 112c formed on the center line 108 of the recording track and the magnetic part 112b which is adjacent to the magnetic parts 112a, 112c and is formed on the center line 107 of another recording track that is next to the center line 108 of the recording track in the outer radial direction of the concentric circle are arranged in such a manner that a distance d1 between a corner a1 of the magnetic part 112a on the center line 108 of the recording track that is positioned on the outermost peripheral side of the concentric circles and a corner b1 of the magnetic part 112b on the another recording track that is positioned at the innermost peripheral side of the concentric circles is equal to a distance d2 between a corner c1 of the magnetic part 112c adjacent to the magnetic part 112a that is positioned at the outermost peripheral side of the concentric circles and the corner b1 of the magnetic part 112b on the another recording track that is positioned at the innermost peripheral side of the concentric circles.

To be more specific, an isosceles triangle is formed by the corners a1, b1 and c1 with the distance d1 between the corner a1 of the magnetic part 112a and the corner b1 of the magnetic part 112b being equal to the distance d2 between the corner b1 of the magnetic part 112b and the corner c1 of the magnetic part 112c as shown in FIG. 1.

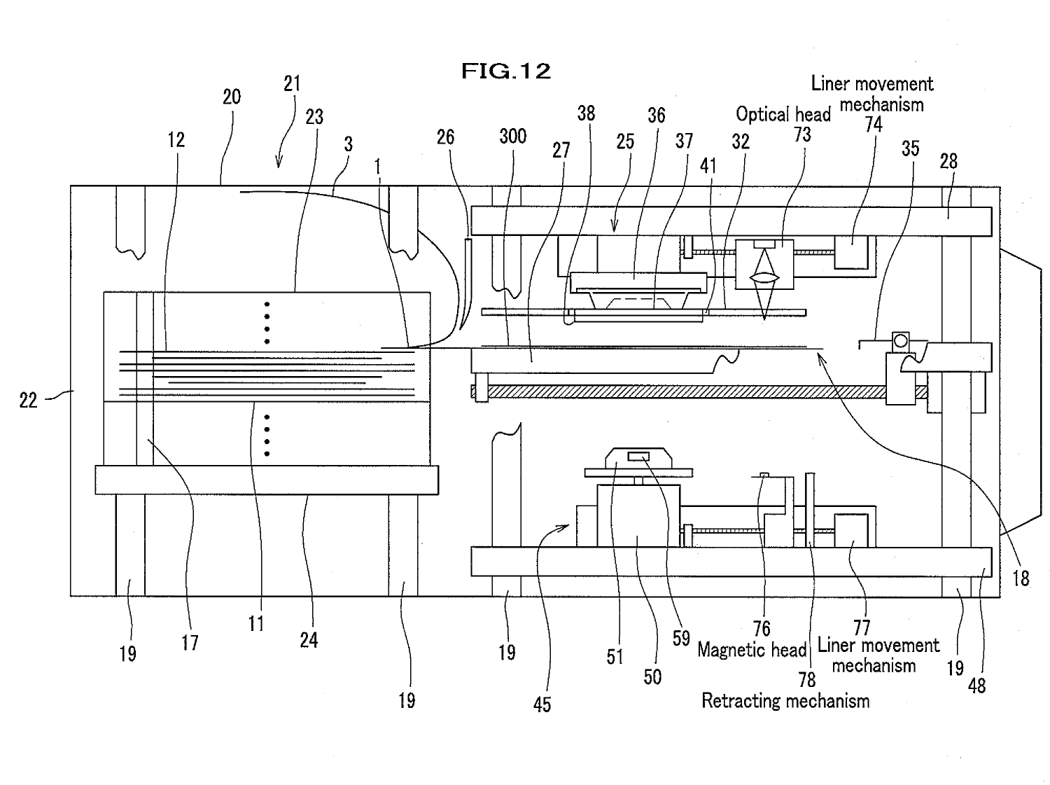

It is preferable that the magnetic part 112 and the non-magnetic part 110 of the magnetic recording medium 100 are equal in height in the thickness direction (see FIG. 12) and are flat. This allows to suppress the fluctuation of the floating slider 96. The magnetic part 112 is preferably a magnetic material having high holding power of perpendicular magnetic recording. As shown in FIG. 1, an area of the magnetic part 112 in a plain view of the magnetic recording medium 100 shown in FIG. 1 is not limited, however, it is preferably equal to or less than approximately several hundreds square nanometers.

In accordance with the embodiment as above, the fine area magnetic parts 112 which record information on concentric recording tracks of the magnetic recording medium 100 are arranged in a constant distance with angles between the center lines 107, 108 and 109 of the recording tracks and the slider 96 being inclined by the yaw angle θ. With this configuration, the inclination of the fine area magnetic parts 112 and that of the recoding/reproducing/heating elements (including the reading element 103, the writing element 104 and the heating element 105) are made to be equal. Specifically, since the area of the fine area magnetic parts 112 and that of the recoding/reproducing/heating elements matches, it is possible to efficiently heat and magnetize a wide area of the magnetic part 112 when recording. This configuration also makes it possible to efficiently catch a magnetic flux when reproducing, which enhances detection sensitivity.

Furthermore, the magnetic parts 112 in adjacent recording tracks are arranged in such a manner that distances d1, d2 between the vertices of the magnetic parts 112 which are in adjacent recording tracks and are opposed to each other (i.e. the parts of the magnetic parts 112 which are the closet to each other) are equal. This configuration allows to lengthen the distance between the magnetic parts 112 as long as possible even if the distance between adjacent tracks is made small. Thus, a magnetic field of one of the magnetic parts 112 is least affected by a magnetic field of the other magnetic parts 112, which enhances recording density.

At recording tracks where the yaw angle θ of the slider 96 is large, recording width Rd in the radial direction becomes narrow since the magnetic parts 112 in these recording tracks are inclined by the same angle as the large yaw angle θ of the slider 96. Concentric recording pitch Rp also becomes narrow corresponding to the recording width Rd, which enhances recording density.

Fine area magnetic parts may not be necessarily arrayed as the magnetic parts 112 provided on the magnetic recording medium 100 that is rotated, but magnetic bands may be formed on the concentric recording tracks (not shown). Also in this configuration, the width of the magnetic band can be changed corresponding to the yaw angle θ of the slider 96 as described before. More specifically, at recording tracks where the yaw angle θ of the slider 96 is large, the width Rd of the magnetic band can be made narrower, which allows to narrow the concentric recording pitch Rp and enhance recording density.

Next, a configuration example of the embodiment is explained in detail referring to the accompanying drawings. The configuration example mainly relates to the configuration of a magnetic recording medium. FIG. 2 shows the magnetic recording medium which is set in a recording and reproducing apparatus. FIG. 2 is an enlarged side cross sectional view showing the relationship between the magnetic recording medium and a slider including a magnetic head, etc.

As shown in FIG. 2, the magnetic recording medium 100 for recording information includes: a substrate 120; a soft magnetic film 121 for passing the magnetic flux 102 which is formed on the substrate 120; perpendicular recording magnetic films 122 which are formed on the soft magnetic film in a constant interval for recording information; heat absorbing films which are formed on the magnetic films 122 for collecting heats; nonmagnetic films 110 which do not record information and are formed for separating the adjacent magnetic films 122 and the adjacent heat absorbing films 123; and a lubrication film 124 for covering the heat absorbing films 123 and the nonmagnetic films 110. It is to be noted that the substrate 120 is generally formed in a disciform.

The distal end of the slider 96 includes the heating element 105, the reading element 103 and the writing element 104 between the heating element 105 and the reading element 103. The writing element 104 includes a magnetic poll 118 and a coil 119 wound around the magnetic poll 118. If electric current is flowed through the coil 119, the magnetic flux 102 is generated and the magnetic film 122 is magnetized.

The magnetic films 122 and the heat absorbing films 123 formed on the magnetic films 122 are arrayed in a constant interval as fine area magnetic parts, or are formed in a ring shape on the concentric recording tracks. Parts other than the magnetic films 122 and the heat absorbing films 123 are formed of the nonmagnetic films 110. The relationships of the thermophysical properties of these films are as follows: the thermal conductivity of the heat absorbing film 123>the thermal conductivity of the magnetic film 122>the thermal conductivity of the nonmagnetic film 110.

With the above configuration, heat energy is efficiently caught by the heat absorbing film 123 and is transferred to the magnetic film 122. More specifically, when writing information on the magnetic recording medium 100, the heat absorbing film 123 is heated with light or electromagnetic wave irradiated from the heating element 105. At this time, most of the heat converted from the light or electromagnetic wave and collected highly-efficiently by the heat absorbing film 123 is transferred to the magnetic film 122 whose thermal conductivity is higher than that of the nonmagnetic film 110, whereby the magnetic film 122 can be efficiently heated.

Since the heat absorbing film 123 has a heat accumulation effect, temperature decrease of the writing element 104 can be suppressed. Thus, the temperature of the magnetic film 122 of high holding power is increased to be equal to or more than Curie point, and the magnetic pole of the magnetic film 122 is reversed and magnetized by the magnetic flux 102 from the writing element 104. Moreover, the amount of heats transferred to the adjacent magnetic film 122 is small, which reduces the risk that the magnetic pole of the adjacent magnetic film 122 is reversed. Further, since the thermal conductivity of the nonmagnetic film 110 is low, the amount of heat transferred to the adjacent magnetic film 122 is small even if the nonmagnetic film 110 is heated, which reduces the risk that the adjacent magnetic film 122 is heated.

Moreover, with the above configuration, the power of the heating element 105 can be designed to be lower, and the temperature decrease of the area between the heat absorbing film 123 and the writing element 104 can be suppressed because the heat absorbing film 123 has a heat accumulation effect.

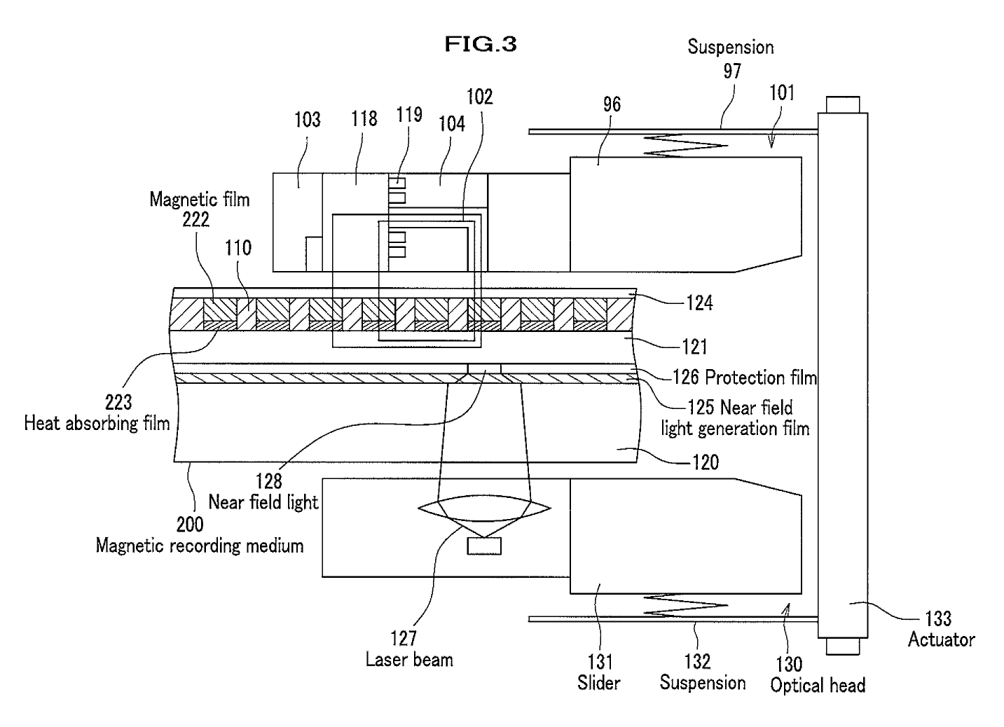

Further, the light spot radius of laser beam from the heating element 105 can be made larger by forming a near field light generation film 125 (e.g. FIG. 3) on the heat absorbing film 123 as described later. This enhances heating force.

Examples of materials used for the magnetic recording medium are described below.

Nonmagnetic materials such as aluminum, glass and resin can be used for the substrate 120. NiFe alloy, FeCo alloy or the like may be used for the soft magnetic film 121. Perpendicular recording magnetic film made of CoPtCr alloy, CoCr alloy or the like may be used for the magnetic film 122. C, Au, Ag, Cu, diamond-like-carbon (DLC), or the like may be used for the heat absorbing film 123. Al, Cu, Ag, Au, or As, Sb, Bi, Si, Ge, resin that have low conductivity may be used for the nonmagnetic film 110.

### Second Embodiment

Next, a second embodiment of the present invention is described with reference to the accompanying drawings. The second embodiment corresponds to an example configuration of the first embodiment, and like reference numerals are assigned to corresponding parts that are common between the first embodiment and the second embodiment, and descriptions thereof will be omitted.

FIG. 3 shows a magnetic recording medium according to the second embodiment which is set in a recording and reproducing apparatus. FIG. 3 is a side cross sectional view showing the relationship between the magnetic recording medium and a slider including a magnetic head, etc.

As shown in FIG. 3, a magnetic recording medium 200 for recording information includes: the substrate 120; and the near field light generation film 125 which is formed on the substrate 120. If a light is irradiated on the near field light generation film 125, a fine center part of the light spot becomes transparent to generate a near field light 128. The magnetic recording medium 200 further includes: a protection film 126 which is formed on the near field light generation film 125; a soft magnetic film 121 which is formed on the protection film 126 and passes the magnetic flux 102; heat absorbing films 223 which are formed on the soft magnetic film 121 for transferring heats; perpendicular recording magnetic films 222 which are formed on the heat absorbing films 223 for recording information; nonmagnetic films 110 which do not record information and separate the adjacent magnetic films 222 and the adjacent heat absorbing films 223; and a lubrication film 124 which is formed on the magnetic films 222 and the nonmagnetic films 110. It is to be noted that the substrate 120 is generally formed in a disciform in a plain view.

The recording and reproducing apparatus includes: an optical head 130 which levitates from the magnetic recording medium 200 with a small space kept between the optical head 130 and the magnetic recording medium 200 and irradiates laser beam 127 on the magnetic films 222 of the magnetic recording medium 200; a slider 131 for levitating the optical head 130 by aerodynamic force of the magnetic recording medium 200; and a rotational actuator 133 to which the magnetic head 101 and the optical head 130 are respectively fixed via suspensions 97, 132 having a spring effect, and which moves the magnetic head 101 and the optical head 130 over the concentric recording tracks.

The magnetic flux generation part of the writing element 104 is arranged in a position opposed to the near field light 128 generated by the optical head 130. The magnetic films 222 formed on the heat absorbing films 223 and the heat absorbing films 223 are arrayed in a constant distance as fine area magnetic parts, or are formed in a ring shape on the concentric recording tracks. It is to be noted that the heat absorbing films 223 may be omitted.

Parts other than the magnetic films 222 and the heat absorbing films 223 are formed of the nonmagnetic film 110. The relationships of the thermophysical properties of these films are as follows: the thermal conductivity of the heat absorbing film 223>the thermal conductivity of the magnetic film 222>the thermal conductivity of the nonmagnetic film 110.

Antimony, diarylethene or the like may be used for the near field light generation film. As for the substrate 120, the soft magnetic film 121, the magnetic film 222 and the heat absorbing film 223, the same materials as those used for the first embodiment described above may be used.

When writing information on the magnetic recording medium 200, the laser beam 127 is irradiated on the near field light generation film 125 from the optical head 130. The near field light generation film 125 becomes transparent in a fine area of the center part of a light spot and generates the near field light 128, which is a fine light spot. The near field light 128 heats a fine area of the heat absorbing film 223. The light energy is efficiently converted into heat energy by the heat absorbing film 223, whereby the heat absorbing film 223 is heated. Most of the heat of the heated heat absorbing film 223 is transferred to the magnetic film 222 whose thermal conductivity is higher than the nonmagnetic film 110, which allows to efficiently heat the magnetic film 222.

Since the temperature of the magnetic film 222 is increased to be equal to or more than Curie point with the above configuration, the magnetic pole of the magnetic film 222 of high holding power is reversed with a small magnet power by the magnetic flux 102 of the writing element and the magnetic film 222 is magnetized. Since only small amount of the heat is transferred to the adjacent magnetic film 222, magnetization of the adjacent magnetic film 222 is less likely to be reversed. Even if the nonmagnetic film 110 whose thermal conductivity is low is heated, the amount of heat transferred to the adjacent magnetic film 222 is small, and thus the adjacent magnetic film 222 is hardly heated.

With the above configuration, the position of the part which generates a magnetic flux and that of the near field light 128 are opposed to each other, and thus the magnetic film 222 can be magnetized by the magnetic flux 102 of the writing element 104 while the magnetic film 222 is being heated, which increases data writing speed. Therefore, the power of the writing element 104 and the power of the laser beam 127 can be set to be lower.

In the second embodiment, the near field light generation film 125 is formed on the heat absorbing film 223 as shown in FIG. 3, however, the near field light generation film 125 may be directly formed on the magnetic film 222 without the heat absorbing film 223 (the configuration is not shown). With this configuration, heating force can be increased since the light spot diameter of the laser beam 127 from the heating element 105 becomes large. Moreover, the magnetic films 222 may be formed on both sides of the substrate 120, and the recording and reproducing apparatus may be configured in such a manner that the magnetic head 101 faces the both sides of the magnetic film 222. This configuration allows to record data on or reproduce data from the both sides of the magnetic recording medium (this configuration is not shown).

### Third Embodiment

Next, a third embodiment of the present invention is described with reference to the accompanying drawings. The third embodiment corresponds to one of the configuration examples of the first embodiment. Thus, parts of the third embodiment that correspond to those in the first embodiment and the second embodiment are assigned like reference numerals, and the description thereof is omitted.

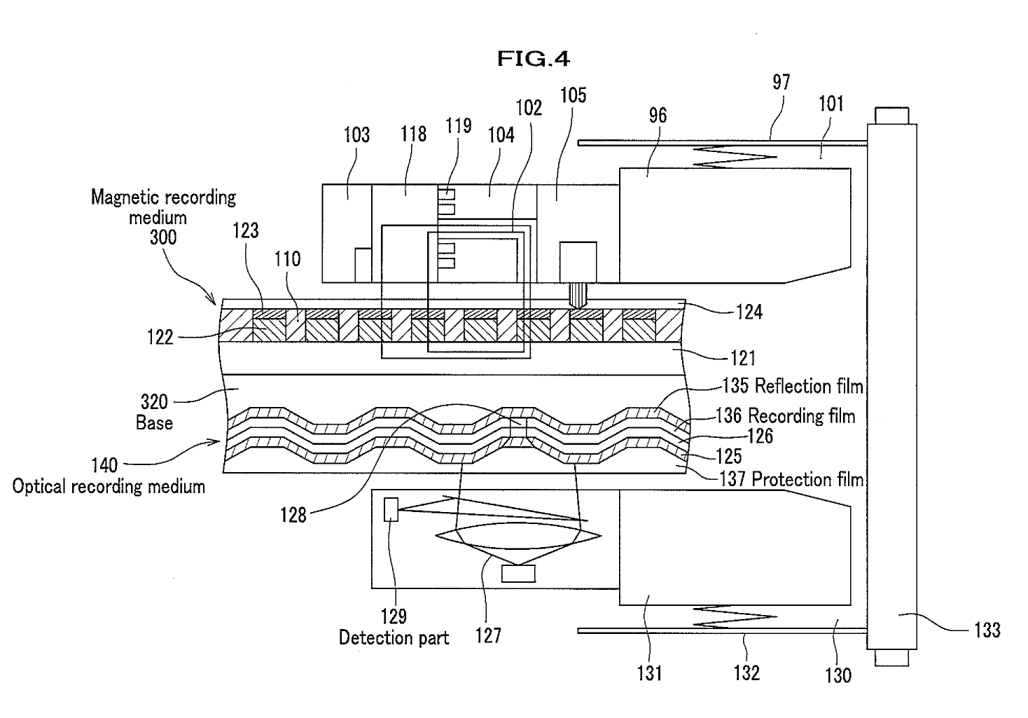

FIG. 4 shows a magnetic recording medium according to the third embodiment which is set in a recording and reproducing apparatus. FIG. 4 is an enlarged side cross sectional side view showing the relationship between the magnetic recording medium and a slider including a magnetic head, etc.

As shown in FIG. 4A, a magnetic recording medium 300 according to the third embodiment includes an optical recording medium 140 which is formed by forming recording films for optical recording on a side of the substrate 320 which is opposite to a side on which the magnetic films are formed, in addition to the magnetic films for magnetic recording provided on the surface of the magnetic recording medium 100 according to the first embodiment shown in FIG. 2.

The optical recording medium 140 includes, as shown in FIG. 4, a substrate 320 on which lands and grooves are formed, a reflection film 135 formed on the lower side of the substrate 320 (lower side in FIG. 4), a recording film 136 formed on the lower side of the reflection film 135, a protection film 126 formed on the lower side of the recording film 136, the near field light generation film 125 which is formed on the lower side of the protection film 126 and generates the near field light 128, and a protection film 137 which is formed at the bottom side as external surface and flattens convex and concave portions made by the lands and grooves.

The recording and reproducing apparatus includes: an optical head 130 which levitates from the optical recording medium 140 with a small space kept between the optical head 130 and the optical recording medium 140 and irradiates the laser beam 127 on the optical recording medium 140; a detection part 129 for detecting reflection light from the optical recording medium 140; the rectangular parallelepiped slider 131 for levitating the optical head 130 from the optical recording medium 140 by an aerodynamic force; and the rotational actuator 133 to which the magnetic head 101 and the optical head 130 are fixed via the suspensions 97, 132 having a spring effect and which moves the magnetic head 101 and the optical head 130 over the concentric recording tracks.

The positions of the magnetic films 122 of the magnetic recording track and the lands and the grooves for optical recording are preferably matched.

A near field light generation means may be configured in such a manner that the protection film 126 and the near field light generation film 125 are removed from the optical recording medium 140 and are provided to the optical head 130 (not shown). Furthermore, because the optical head 130 moves integrally with the magnetic head 101, servo information of the optical recording medium 14 may be omitted by positioning a track with the magnetic recording medium 300 and the magnetic head 101. Thus, the lands and grooves may be omitted from the optical recording medium 140 (not shown). The magnetic recording medium 300 and the optical recording medium 140 may be manufactured separately and then be stuck together (not shown).

In accordance with the third embodiment, it is possible to access information in a high speed by using the magnetic recording while stoting information to be stored for a long time or information not to be altered by the optical recording with using only one disk. Thus, the size of the recording and reproducing apparatus can be reduced.

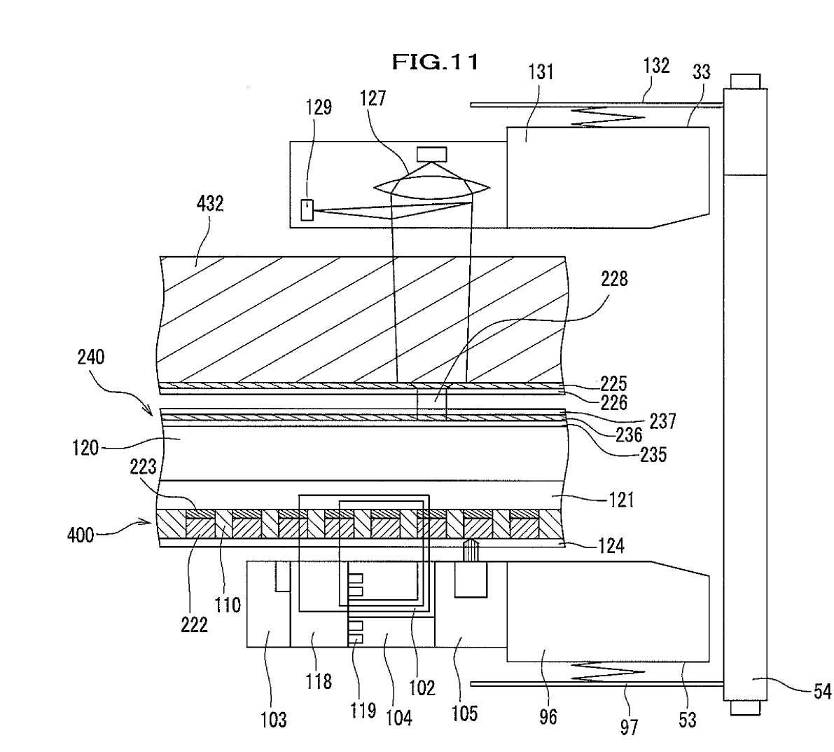

As described before, it is also possible to omit the lands and the grooves of the optical recording medium 140 if the recording and reproducing apparatus is configured in such a manner that the magnetic recording medium 300 and the magnetic head 101 perform positioning of a track (e.g. the configuration shown in FIG. 11). This configuration enables to reduce the cost of the magnetic recording medium 300.

### Fourth Embodiment

Examples of a fourth embodiment of the present invention are described below with reference to the accompanying drawings. The fourth embodiment relates to a recording and reproducing apparatus including the embodiments described before, and parts of the fourth embodiment corresponding to those of the first to third embodiments are assigned like reference numerals, and description thereof will be omitted.

### First Example

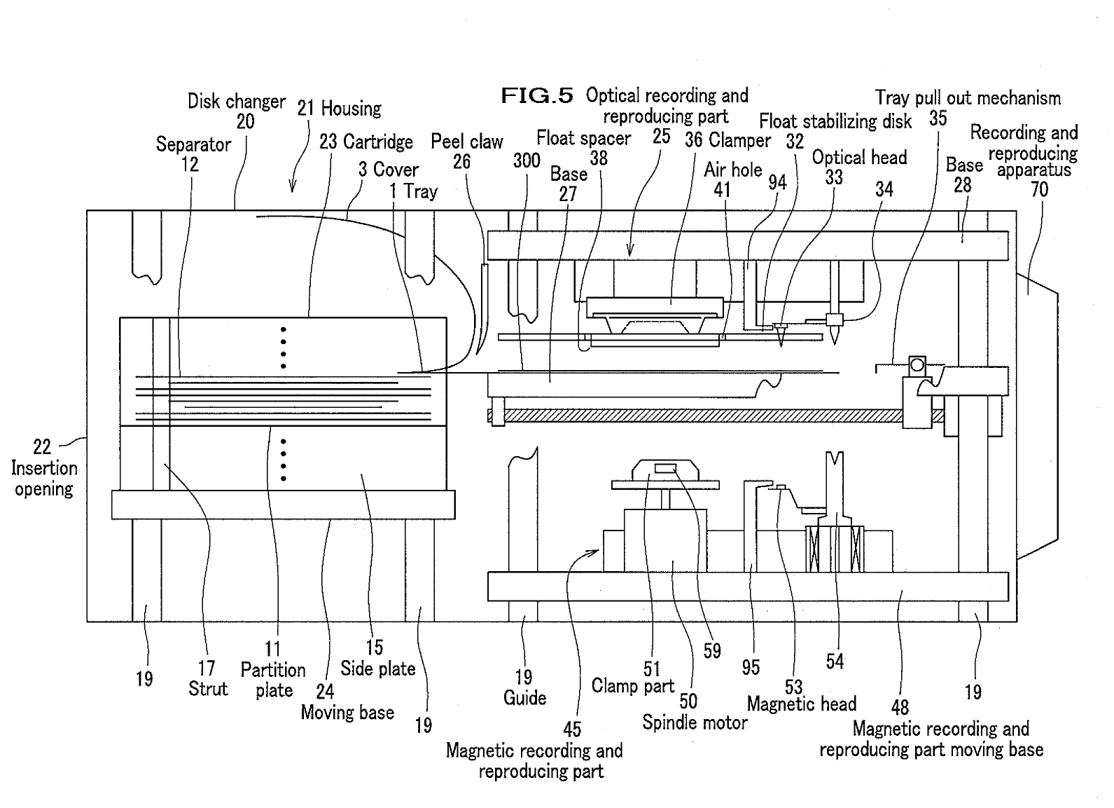

FIGS. 5 to 9 show an example of a disk changer which provides a magnetic recording medium 300 to a recording and reproducing apparatus 70 from a cartridge 23 which stores a plurality of thin sheet-like magnetic recording media 300 according to the first example of the fourth embodiment.

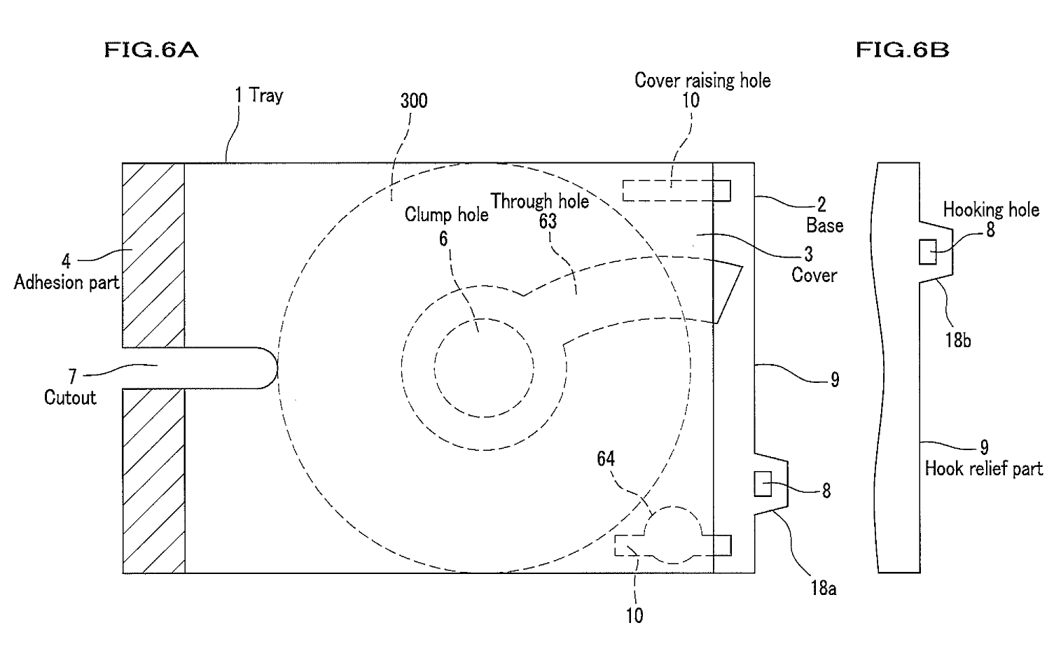

FIG. 5 shows an entire configuration of the disk changer 20 including a cartridge moving part (left side of the apparatus) for moving the cartridge 23 up and down and a recording and reproducing apparatus 70 (right side of the apparatus) for recording data on or reproducing data from the magnetic recording medium 300. In FIG. 5, a tray 1 is pulled out from the cartridge 23, and a cover 3 is removed. In the following explanation, FIG. 5 is referred to as appropriate as well as FIGS. 6A to 9.

FIG. 6A shows a configuration of the tray 1 which stores the disciform magnetic recording medium 300. FIG. 6B shows a configuration of the tray 1 in which a hooking hole 8, which is described later, is arranged in a different position than that of the configuration shown in FIG. 6A, and the other components are arranged in the same manner as those shown in FIG. 6A and the description thereof is omitted.

The tray 1 stores a plurality of magnetic recording media 300 . . . between the cover 3 and a base material 2 as shown in FIG. 6A, and is housed in the cartridge 23 (see FIG. 5).

One tray 1 stores approximately ten magnetic recording media 300, and approximately 50 to 100 magnetic recording media 300 are stored in the cartridge 23, however, the number of magnetic recording media 300 to be stored is not limited to the number described above.

The cover 3 shown in FIG. 6A is attached to the base material 2 at an adhesion part 4. The base material 2 includes: a cover lifting hole 10 through which a protruded member for lifting the cover 3 passes; a hole 64 for connecting an optical head 33 which is disposed in the upper side of the recording and reproducing apparatus 70 shown in FIG. 5 to the rotation actuator 54 which is provided with the magnetic head 53 and is disposed in the lower side of the recording and reproducing apparatus 70; a through-hole 63 through which the clump part 51 passes and which allows the magnetic head 53 to directly face the magnetic recording medium 300; a tag 18a which is provided with the hooking hole 8 for hooking a hook when the tray 1 is pulled out from the cartridge 23 (a tag 18b in FIG. 6B); and a hook relief part 9 for preventing the hook from being in contact with adjacent tray when pulling out a tray.

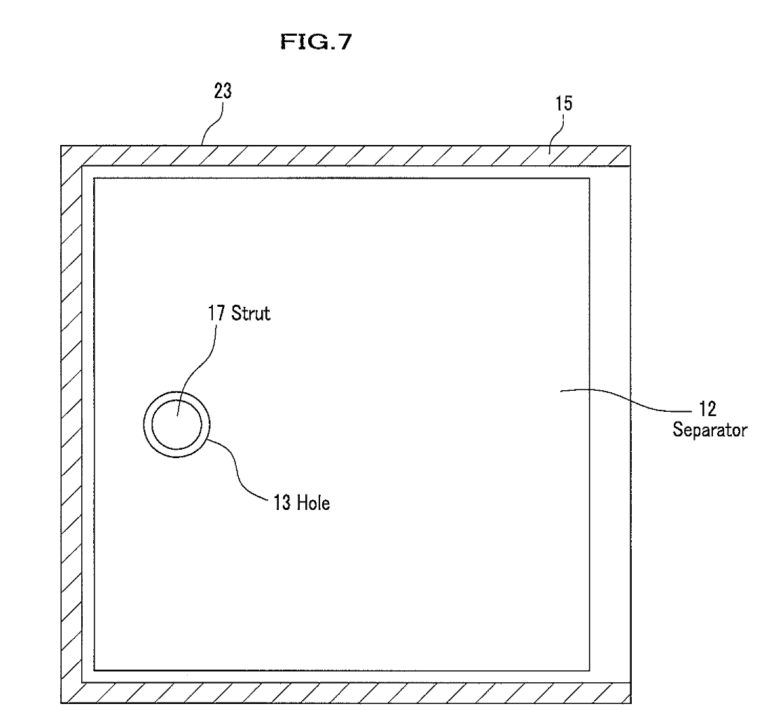

As shown in FIGS. 6A and 6B, the tags 18a, 18b and the hook relief part 9 are displaced by each tray. The tags 18a, 18b are arranged outside of the through-hole 63 so that the tags 18a, 18b do not hook into the through-hole 63 when the tray is moved. In the magnetic recording medium 300, the clump part 51 is inserted through a clump hole 6, and a strut 17, which is described later, is inserted through a cutout 7 (see FIG. 7) so that the magnetic recording medium 300 is not moved.

The tray 1 is approximately width 91 mm×length 125 mm, the thickness of the base material 2 is approximately 0.1 mm to 0.3 mm and the thickness of the cover 3 is preferably approximately 0.05 mm to 0.1 mm, however, the size of these parts is not limited to those described above.

FIG. 7 shows a configuration of a separator 12 provided to the cartridge 23. FIG. 7 shows a cross section of a side plate 15 of the cartridge 23 (see FIG. 5). The separator 12 is disposed between adjacent trays 1, 1 so that the tray 1 is not mistakenly pulled out which is adjacent to the tray 1 to be pulled out when the tray 1 is pulled out from the cartridge 23. A hole 13 is bored through the separator 12, and the strut 17 arranged in the cartridge 23 in a standing condition is inserted through the hole 13 so that the separator 12 is not moved in the horizontal direction, which is the direction the tray 1 is pulled out form cartridge 23, while the separator 12 can be moved in the vertical direction in FIG. 5. Thus, the cartridge 23 is configured not to be pulled out together with the tray 1.

FIG. 8 is a plain view of the recording and reproducing apparatus 70 shown in FIG. 5 seen downward from the clamper 36. FIG. 8 shows a state of the disk changer 20 where the tag 18 (18a or 18b (see FIGS. 6A and 6B)) of the tray 1 specified from the cartridge 23 shown in FIG. 5 is hooked by a tray pull-out mechanism 35, and the magnetic recording medium 300 on the tray 1 is pulled out from the cartridge 23, removing the cover 3 (see FIG. 5), and is transferred to the magnetic recording and reproducing part 45. A tray retainer 84 presses the tray 1 to a base 27 so that the tray 1 is not attracted to the magnetic recording medium 300 when the magnetic recording medium 300 is rotated.

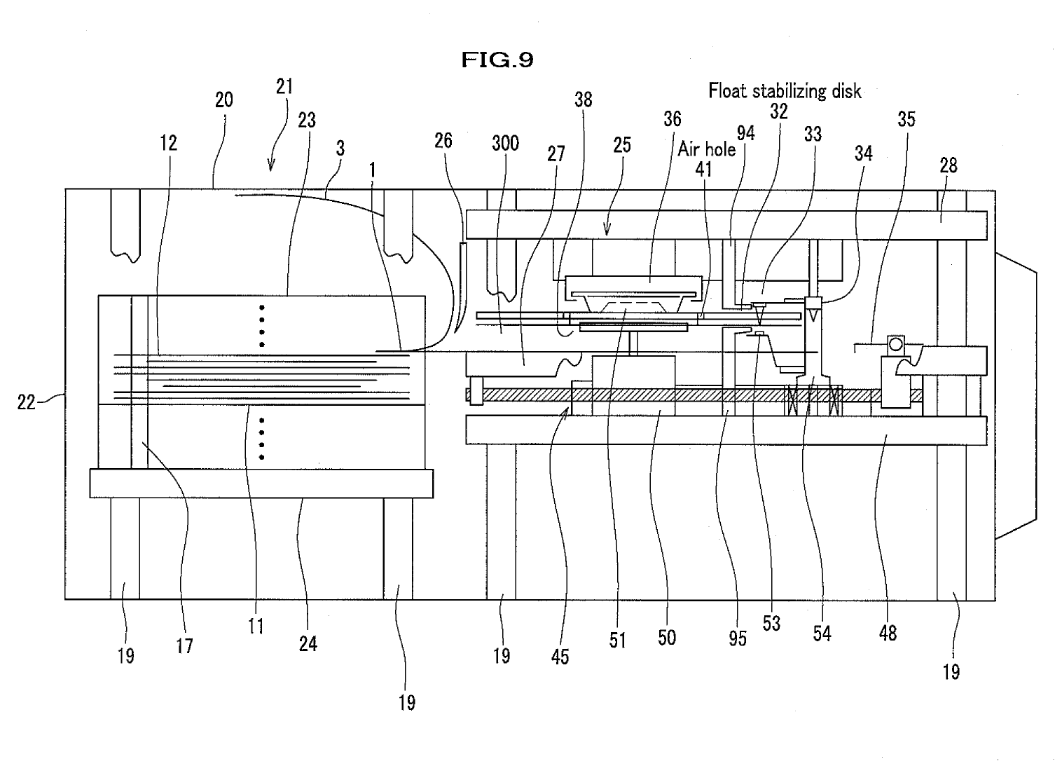

FIG. 9 shows a state of the disk changer 20 where the recording and reproducing part 45 is moved upward from the state shown in FIG. 8, a clump part 51 is inserted through the clump hole 6 (see FIGS. 6A and 6B) of the magnetic recording medium 300 on the tray 1, and the clump part 51 and the clamper 36 is engaged to fix the magnetic recording medium 300 to a spindle motor 50. At this time, the magnetic head 53 is passed through the through-hole 63 of the tray 1, and the magnetic recording medium 300 is in a position where the magnetic recording medium 300 does not come in contact with the tray 1.

Next, the configuration of the disk changer 20 is explained, referring to FIG. 5.

The disk changer 20 includes a housing 21, an insertion opening 22 provided on the housing 21 through which the cartridge 23 is inserted, and a guide (not shown) for a moving base. The moving base, and moving parts of the tray pull-out mechanism and an optical part moving mechanism are configured in such a manner that their motive energy is supplied from a driving source (not shown) for their movement.

In the cartridge 23, the tray 1 which stores the magnetic recording medium 300 shown in FIGS. 6A and 6B and the separator 12 shown in FIG. 7 are alternately stacked. Partition plates 11 for receiving the load of the trays are provided to the cartridge 23 every predetermined number of the trays.

A moving base 24 of the cartridge 23 on which the cartridge 23 is placed moves up and down so as to allow the recording and reproducing apparatus 70 to position the target tray 1.

The recording and reproducing apparatus 70 includes: the tray pull-out mechanism 35 for pulling out the tray 1; the magnetic recording and reproducing part 45 which is arranged at the lower side of the tray pull-out mechanism 35 for recording data on or reproducing data from the magnetic recording medium 300; a magnetic recording and reproducing part moving base 48 to which the magnetic recording and reproducing part 45 is attached and which moves up and down; the clamper 36 which is placed on the upper side of the tray pull-out mechanism 35 for fixing the magnetic recording medium 300 to the clump part 51 of the recording and reproducing part 45; an optical recording and reproducing part 25 for heating the magnetic recording medium 300 and recording data on or reproducing data from an optical recording medium provided on the magnetic recording medium 300; and a base 28 to which the optical recording and reproducing part 25 is attached. The magnetic recording and reproducing part moving base 48 is guided by a guide 19 when it moves.

As shown in FIG. 8, the tray pull-out mechanism 35 includes: a horizontal movement mechanism 89 which is provided to the base 27 on which the tray 1 pulled out from the cartridge 23 is placed, and moves toward or away from the cartridge; a hook mechanism 91 which is provided to the horizontal movement mechanism 89 for pulling out the tray 1 by hanging the hook 93 on the hooking hole 8 provided to the base material 2 of the tray 1. The hook mechanism 91 moves orthogonally to the horizontal movement mechanism 89 for selecting a tag. A guide 92 includes a sector cutout at a distal end thereof. The tag 18 is inserted into the sector cutout at the distal end of the guide 92 and is guided to a hook 93. The hook 93 is supported by a shaft 90 in such a manner that the hook 93 is rotatable about the shaft 90. The horizontal movement mechanism 89 is supported by a linear bearing 86 and a shaft 87.

A peel claw 26 (see FIG. 5) peels the cover 3 of the tray 1 shown in FIGS. 6A and 6B. When the tray 1 is pulled out by the tray pull-out mechanism 35, the cover 3 is lifted by a protruded member inserted through the cover lifting hole 10, which is provided to the base material 2 of the tray 1 shown in FIGS. 6A and 6B. Then, an end of the cover 3 comes in contact with the peel claw 26, and the cover 3 is peeled by the peel claw 26.

The magnetic recording and reproducing part 45 includes: the spindle motor 50 for rotating the magnetic recording medium 300; the clump part 51 which is provided to the spindle motor 50 for fixing the magnetic recording medium 300; the magnetic head 53 for writing information on or reading information from the magnetic recording medium 300; the rotation actuator 54 for moving the magnetic head 53 in the radial direction of the magnetic recording medium 300; and a head retracting mechanism 95 for retracting the magnetic head 53 from the magnetic recording medium 300.

The clamper 36 is attracted to the clump part 51 by magnetic attracting force of a ferromagnetic material (a piece of iron or the like) embedded in the clamper 36 and the permanent magnet 59 embedded in the clump part 51, and fixes the magnetic recording medium 300 to the clump part 51. The clamper 36 may include the permanent magnet 59, and the clump part 51 may include the ferromagnetic material to fix the magnetic recording medium 300.

A float stabilizing disk 32 includes an air hole 41 in its inner circumferential side, and is attached to the clamper 36 as shown in FIG. 9. A float spacer 38 for creating a space between the float stabilizing disk 32 and the magnetic recording medium 300 is attached to the float stabilizing disk 32. The float stabilizing disk 32 has an aerodynamic-force vibration-suppression function so that the magnetic recording medium 300 can be rotated without face swing vibration. Specifically, when the magnetic recording medium 300 and the float stabilizing disk 32 are rotated, air flows between the magnetic recording medium 300 and the float stabilizing disk 32 from the air hole 41 provided at the inner circumference side to the outer circumference of the float stabilizing disk 32, whereby negative-pressure is generated. Thus, the magnetic recording medium 300 is floated in a state where the magnetic recording medium 300 is attracted to the float stabilizing disk 32, and is stably rotated without face swing vibration.

The diameter of the float stabilizing disk 32 is preferably the same as that of the magnetic recording medium 300, however, it may be smaller than that of the magnetic recording medium 300.

As shown in FIG. 5 or FIG. 9, an optical recording and reproducing part 25 includes: the clamper 36 which fixes the magnetic recording medium 300 and is provided with the float stabilizing disk 32; the optical head 33 for heating the magnetic recording medium 300 and writing data on or reading data from the magnetic recording medium 300; the rotation actuator 34 for moving the optical head 33 in the radial direction of the magnetic recording medium 300; and the head retracting mechanism 94 for retracting the optical head 33 from the magnetic recording medium 300.

The float stabilizing disk 32 and the clamper 36 are preferably made in a single-piece to ensure the flatness of the float stabilizing disk 32, however, the float stabilizing disk 32 and the clamper 36 may be formed of separate bodies which are adhered to each other via an elastic body, or are flexibly connected to each other with some play therebetween so that the float stabilizing disk 32 and the clamper 36 can move. Ensuring the flatness of the float stabilizing disk 32 allows rotation of the float stabilizing disk 32 to be automatically adjusted by centrifugal force of the rotation, whereby the float stabilizing disk 32 can rotate flatly.

Materials that are light and can be rotated without face swing vibration, such as glass, a resin material, metal, ceramics, or the like are preferably used for the float stabilizing disk 32, however, materials for the float stabilizing disk 32 are not limited to these materials.

Next, the recording and reproducing operation of the disk changer 20 is explained.

As shown in FIG. 5, when the moving base 24 of the cartridge 23 is moved, the tray 1 specified in the cartridge 23 is positioned in a predetermined position of the tray pull-out mechanism 35 of the recording and reproducing apparatus 70.

Then, the tray pull-out mechanism 35 is moved, the tray 1 is pulled out from the cartridge 23, and the magnetic recording medium 300 is moved to a position where the magnetic recording medium 300 can be fixed to the magnetic recording and reproducing part 45. At this time, the cover 3 is peeled from the tray 1 by the peel claw 26. A part of the tray 1 remains in the cartridge 23 so that the tray 1 can be easily returned to the cartridge 23.

The magnetic recording and reproducing part moving base 48 shown in FIG. 9 is moved upward, and the clump part 51 of the magnetic recording and reproducing part 45 is inserted into the clump hole 6 of the magnetic recording medium 300. Further, the magnetic recording and reproducing part moving base 48 is moved upward, and the clamper 36 is set in the clump part 51, whereby the magnetic recording medium 300 is fixed to the clump part 51. Then the magnetic recording and reproducing part moving base 48 is moved so that the clamper 36 can move freely.

The rotation actuator 54 is fit into the rotational mechanism 34 for the optical head 33. The magnetic recording medium 300 and the float stabilizing disk 32 are rotated by the spindle motor 50. The rotation actuator 54 is moved so that the magnetic head 53 and the optical head 33 are moved from the head retracting mechanisms 95, 94 to be on the magnetic recording medium 300 and the float stabilizing disk 32, respectively. The magnetic head 53 and the optical head 33 are levitated by aerodynamic force of the magnetic recording medium 300 and the float stabilizing disk 32, and perform recording and reproducing operation.

Next, the operation for returning the magnetic recording medium 300 set in the magnetic recording and reproducing part 45 to the cartridge 23 is explained with reference to the accompanying drawings. This operation is an operation that returns the state of the disk changer 20 shown in FIG. 9 to the state shown in FIG. 5. From the state shown in FIG. 9, the rotation actuator 54 is moved, and the magnetic head 53 and the optical head 33 are moved to the head retracting mechanisms 95, 94, respectively.

Then, the spindle motor 50 is stopped, whereby the rotation of the magnetic recording medium 300 and the float stabilizing disk 32 is stopped. The magnetic recording and reproducing part moving base 48 is moved downward, and the clamper 36 is removed from the clump part 51. As shown in FIG. 8, a magnetic recording and reproducing part moving-base 48 is further moved downward, and thus the magnetic recording medium 300 comes in contact with the base material 2 and is removed from the clump part 51. Thus, the magnetic recording medium 300 is returned to the tray 1. Then, the tray pull-out mechanism 35 is moved to return the tray 1 into the cartridge 23. At this time, the magnetic recording medium 300 is covered by the cover 3.

### Second Example

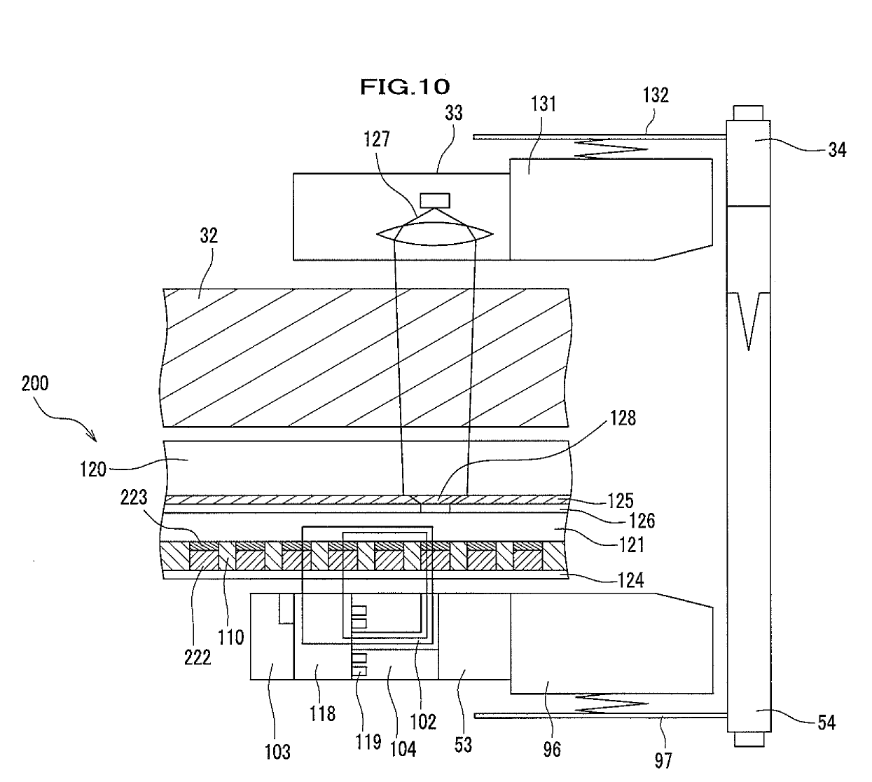

FIG. 10 shows a second example of the recording and reproducing apparatus in which a magnetic recording medium is set in the recording and reproducing apparatus. FIG. 10 is an enlarged side cross sectional view showing the relationship of the magnetic recording medium and a slider including a magnetic head, etc. The recording and reproducing apparatus shown in FIG. 10 has a configuration similar to that of the recording and reproducing apparatus of the second embodiment shown in FIG. 3, but is different from it in that the second example of the recording and reproducing apparatus is configured in such a manner that the laser beam 127 of the optical head 33 irradiates the magnetic recording medium 200 through the float stabilizing disk 32. Transparent glass or polycarbonate that transmit the laser beam 127 can be used for the float stabilizing disk 32. The magnetic head 53 and the optical head 33 may be provided to the rotation actuators 54, 34.

The second example of the recording and reproducing apparatus irradiates the laser beam 127 from the optical head 33 to generate a fine light spot through the near field light generation film 125 formed on the magnetic recording medium 200 so as to heat the magnetic film 222 when the recording and reproducing apparatus is writing information on the magnetic film 222 formed on a thin sheeted magnetic recording medium 200 with the magnetic head 53. With this configuration, the high holding power magnetic film 222 can be magnetically reversed with a small writing power while the adjacent magnetic film 222 can be prevented from being magnetically reversed because the amount of heat transferred to the adjacent magnetic film 222 is small. Thus, the recording and reproducing apparatus can perform stable recording and reproducing of high recording density.

Since the magnetic flux generation part of the writing element 104 of the magnetic head 53 is arranged in a position opposed to a position of the laser beam 127 from the optical head 33, the recording and reproducing apparatus can magnetize the magnetic film 222 with the magnetic flux 102 of the writing element 104 at the same time when the magnetic film 222 is being heated. This realizes high speed writing and reduction of the laser beam power.

### Third Example

FIG. 11 shows a third example of the recording and reproducing apparatus in which a magnetic recording medium is set in the recording and reproducing apparatus. FIG. 11 is an enlarged side cross sectional view showing the relationship of the magnetic recording medium and a slider including a magnetic head. The recording and reproducing apparatus of the third example shown in FIG. 11 has a configuration similar to that of the recording and reproducing apparatus of the third embodiment shown in FIG. 4, but is different from it in that the recording and reproducing apparatus of the third example is configured in such a manner that the laser beam 127 from the optical head 33 is irradiated on the magnetic part 222 formed on a surface of a magnetic recording medium 400 and an optical recording medium 240 formed on the other surface of the magnetic recording medium 400 through a near field light generation film 225 formed on a float stabilizing disk 432.

Furthermore, the optical recording medium 240 is different from the optical recording medium 140 shown in FIG. 4 in that lands and grooves are not formed on the substrate 120, and a reflection film 235, a recording film 236 and a protection film 237 are formed at the top side of the substrate 120 (upper side in FIG. 11) in the order shown in FIG. 11. A protection film 226 is formed on a side of the float stabilizing disk 432 which faces to the optical recording medium 240, and a near field light generation film 225 for generating a near field light 228 is further formed on the upper side of the protection film 226.

Since the magnetic head 53 and the optical head 33 move integrally, the servo information of the optical recording medium 240 may be omitted if a track is positioned by the magnetic recording medium 400 and the magnetic head 53.

With this configuration, it is possible to omit lands and grooves of the optical recording medium 240. Transparent glass or polycarbonate that transmit the laser beam 127 can be used for the float stabilizing disk 432. The near field light generation film 225 may be formed on the optical recording medium 240, and both of the magnetic head 53 and the optical head 33 may be attached to the rotation actuator 54.

In the recording and reproducing apparatus of the third example, the near field light generation film 225 is formed on the float stabilizing disk 432 so that data is recorded on or reproduced from the optical recording medium 240 with a fine light spot, whereby recording and reproducing of high recording density is realized. Providing both of the magnetic recording medium 400 and the optical recording medium 240 to one disk makes it possible that, by using the only one disk, high speed access of information is performed on the magnetic recording medium 400, and information to be stored for a long time or information not to be altered are recorded on the optical recording medium 240, which enhances the reliability of the disk.

If positioning of a track is performed by the magnetic recording medium 400 and the magnetic head 53, lands and grooves of the optical recording medium 240 may be omitted and cost of the optical recording medium 240 can be reduced.

As a modification of the third example, magnetic films may be formed on both sides of the magnetic recording medium, and two magnetic recording and reproducing apparatuses may be provided on the upper side and lower side of the disk changer in such a manner that the sides of the two magnetic recording and reproducing apparatus for recording and reproducing data face to each other. In this modification, a disk changer may be configured to provide the magnetic recording medium which has magnetic films on both sides to the two recording and reproducing apparatuses. This configuration allows to record data on or reproduce data from both sides of the magnetic recording medium. In this case, an optical head may be omitted. It is also possible to configure a large scale data recording and reproducing apparatus by arranging longitudinally and laterally a plurality of the disk changers described above, and providing to each disk changer a mechanism for transferring a cartridge from a cartridge storage.

The sheeted magnetic recording medium used for the third example and the modification of the third example is lighter than a current optical disk using polycarbonate of which thickness is 1.2 mm as a base material. Thus, even if the magnetic recording medium is rotated at more than 10000 rpm, generated centrifugal force becomes smaller, which reduces the risk of damaging the disk. Thus, it is possible to realize an access speed higher than that of a current optical recording medium.

The sheeted magnetic recording medium may be configured in such a manner that a magnetic recording layer or an optical recording layer is formed on a surface of a base made of aluminum, glass, a polycarbonate resin material, a polyester resin material, or the like of which thickness is approximately 0.05 mm 0.2 mm, however, the configuration of the sheeted magnetic recording medium is not limited to this. It is to be noted that one cartridge can store approximately one hundred sheeted magnetic recording media.

### Fourth Example

Next, a fourth example of a disk changer using a thin sheeted magnetic recording medium is explained with reference to FIGS. 12 to 14.

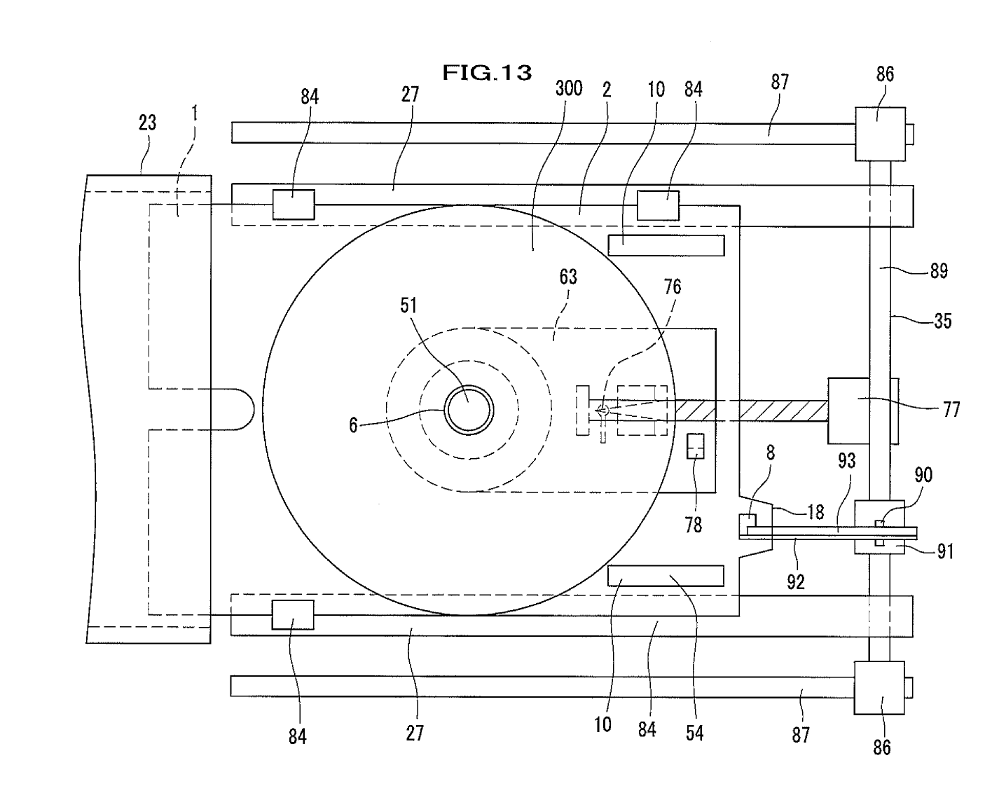

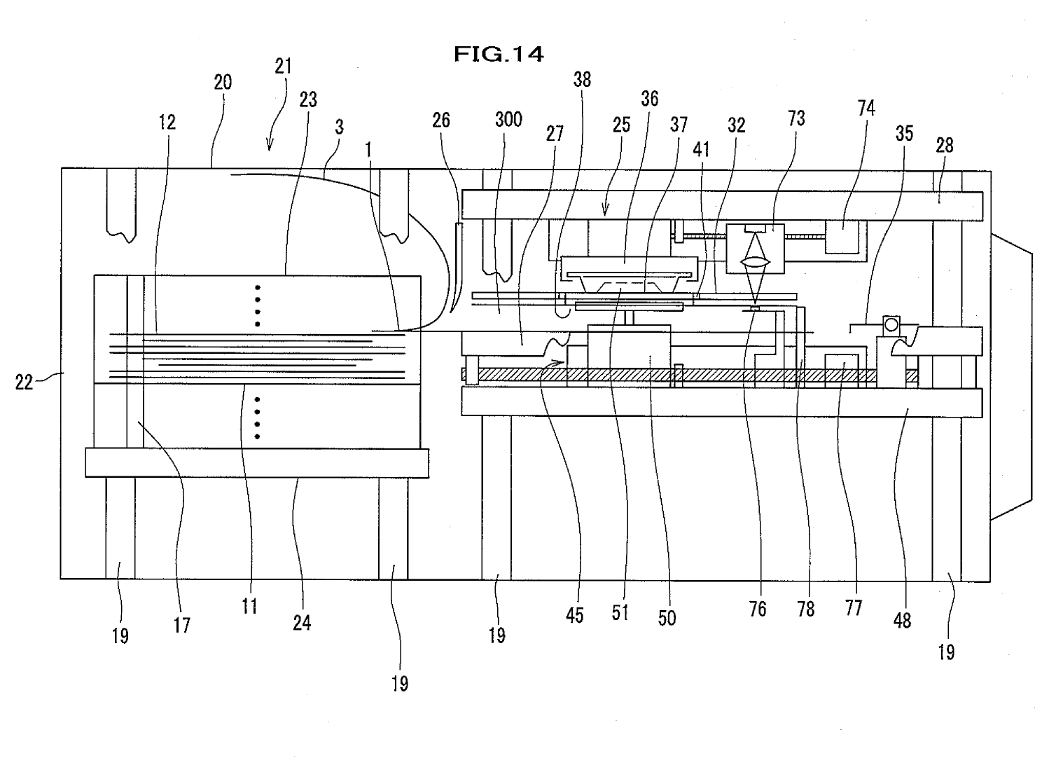

FIG. 12 is a side view of the disk changer according to the fourth example. FIG. 13 is a plain view of the recording and reproducing apparatus shown in FIG. 12 seen downward from the clamper. FIG. 14 is a side view of the disk changer according to the fourth example. In FIG. 14, the disk changer is in a state in where the thin magnetic recording medium shown in FIG. 12 is fixed to a recording and reproducing part.

The disk changer of the fourth example shown in FIG. 12 has a configuration similar to that of the disk changer according to the first example shown in FIG. 5. The recording and reproducing apparatus 70 (the right side of the disk changer in FIG. 12) includes: a magnetic head 76 which is levitated by an aerodynamic force and writes signals on or reads signals from the magnetic recording medium; a linear movement mechanism 77 which linearly moves the magnetic head 76 in the radial direction of the magnetic recording medium 300; a retracting mechanism 78 for retracting the magnetic head 76 from the magnetic recording medium 300; an optical head mechanism 73 which is provided with a focus mechanism and a tracking mechanism for writing signals on or reading signals from the optical recording medium; and a linear movement mechanism 74 for moving the optical head 73 in the radial direction of the magnetic recording medium 300. FIG. 14 shows the disk changer in a state where the tray 1 is pulled out from the cartridge 23, and the cover 3 is peeled.

FIG. 13 is a plain view of the recording and reproducing apparatus shown in FIG. 12 seen downward from the clamper 36. The tag 18 of the tray 1 which is specified from the cartridge 23 is hung by the tray pull-out mechanism 35, and the magnetic recording medium 300 put on the tray 1 is pulled out from the cartridge 23. Then, the cover 3 is peeled, and the magnetic recording medium 300 put on the tray 1 is transferred to the magnetic recording and reproducing part 45. Here, the tray retainer 84 presses the tray 1 to the base 27 so that the tray 1 is not attracted to the magnetic recording medium 300 when the magnetic recording medium 300 is rotated.

FIG. 14 is a side view of the entire disk changer in a state where data can be written on or reproduced from the magnetic recording medium 300. The state of the disk changer is shifted from the state of the disk changer shown in FIG. 12 to the state shown in FIG. 14 by performing the following operations: the recording and reproducing part 45 is moved upward, the clump part 51 is inserted through the clump hole 6 of the magnetic recording medium 300 put on the tray 1, the clump part 51 is fit into the clamper 36, and the magnetic recording medium 300 is fixed to the spindle motor 50. In the state shown in FIG. 14, the magnetic head 76 is inserted through the through-hole 63 of the tray 1, and the magnetic recording medium 300 is not in contact with the tray 1.

If magnetic films are formed on both sides of the thin magnetic recording medium, two recording and reproducing apparatuses are provided on the upper side and the lower side of the disk changer such that the two recording and reproducing apparatuses face to each other, and the magnetic recording medium is inserted between the two recording and reproducing apparatus, it is possible to realize a disk changer which can provide the magnetic recording medium to the two recording and reproducing apparatuses from one cartridge (not shown). This configuration allows to record data on or reproduce data from both sides of the magnetic recording medium. In this case, the optical head mechanism 73 may be omitted. It is also possible to configure a large scale data recording and reproducing apparatus by arranging longitudinally and laterally a plurality of the disk changers described above, and providing to each disk changer a mechanism for transferring a cartridge from a cartridge storage.

The disk of the fourth example which is provided with both of the magnetic recording medium and the optical recording medium makes it possible that, with the only one disk, high speed access of information is performed on the magnetic recording medium, and information to be stored for a long time or information not to be altered are recorded on the optical recording medium.

Furthermore, since the magnetic head 76 and the optical head mechanism 73 are operated independently, it is possible to perform high speed access of information.

If a current optical disk that uses polycarbonate of 1.2 mm thickness as a base material is rotated at a speed equal to or more than 10000 rpm, centrifugal force based on the weight of the optical disk becomes large and the optical disk may be damaged. The sheeted magnetic recording medium according to the present invention has no risk of damaging the magnetic recording medium by its centrifugal force even if the medium is rotated at a speed equal to or more than 10000 rpm since the weight of the medium is lither. This realizes a high speed access of an optical recording medium which has not been realized.

In accordance with the fourth embodiment of the present invention, it is possible to realize a recording and reproducing apparatus whose capacity is increased to cope with the storage capacity increase of the magnetic recording medium.

In accordance with the first to fourth embodiments of the present invention, it is possible to provide a magnetic recording medium on which fine area magnetic areas are patterned which can improve the writing and reading sensitivity of all the magnetic parts formed on the magnetic recording medium. It is also possible to provide a recording and reproducing apparatus which pulls out the large capacity magnetic recording medium from a cartridge storing a plurality of the large capacity magnetic recording media to record data on or reproduce data from the magnetic recording medium.

The embodiments according to the present invention have been explained as aforementioned. However, embodiments of the present invention are not limited to those explanations, and those skilled in the art ascertain the essential characteristics of the present invention and can make the various modifications and variations to the present invention to adapt it to various usages and conditions without departing from the spirit and scope of the claims.

What is claimed is:

1. A magnetic recording medium which is rotated by a recording and reproducing apparatus provided with a slider including a recording and reproducing head to record or reproduce a magnetic recording, comprising:
a plurality of recording tracks which is formed concentrically; and
a plurality of closed shaped magnetic parts which is formed in a predetermined interval on the recording tracks and is formed to be symmetrical with respect to two orthogonal axes in shape,
the shape of the closed shaped magnetic parts being formed by connecting convex curved lines, convex curved lines and straight lines, or straight lines,
the shape of the closed shaped magnetic parts formed by connecting the convex curved lines and straight lines, or connecting the straight lines having internal angles between the connected lines from 90 degree to less than 180 degree, wherein
if the recording and reproducing head which is moved with movement of the slider to record data on or reproduce data from the recording tracks is inclined by a predetermined angle with respect to a tangent line of concentric circles of the recording tracks, the slider being levitated with an aerodynamic force by a predetermined distance from the recording tracks and moving in a radial direction of the concentric circles of the recording tracks,
the magnetic parts are formed in such a manner that one of the two orthogonal axes of the magnetic parts is perpendicular to the recording and reproducing head.

2. The magnetic recording medium according to claim 1, wherein the slider is connected to a rotational actuator which rotates about an axis positioned away from a rotational axis of the recording tracks, via a suspension extending in a normal direction of rotation of the rotational actuator, and
the predetermined angle is varied as the slider is moved in the radial direction of the concentric circles by the rotation of the rotational actuator.

3. The magnetic recording medium according to claim 1, wherein a first magnetic part on a first recording track, a second magnetic part which is on the first recording track and is adjacent to the first magnetic part, and a third magnetic part which is formed on a second recording track adjacent to the first recording track in an outer radial direction of the concentric circles and is adjacent to the first and second magnetic parts which are formed on the first recording track are arranged in such a manner that a distance between a part of the first magnetic part on the first recording track at the outermost side of the concentric circles and a part of the third magnetic part on the second recording track at the innermost side of the concentric circles is equal to a distance between a part of the second magnetic part on the first recording track at the outermost side of the concentric circles and the part of the third magnetic part on the second recording track at the innermost side of the concentric circles.

4. The magnetic recording medium according to claim 2, wherein a first magnetic part on a first recording track, a second magnetic part which is on the first recording track and is adjacent to the first magnetic part, and a third magnetic part which is formed on a second recording track adjacent to the first recording track in an outer radial direction of the concentric circles and is adjacent to the first and second magnetic parts which are formed on the first recording track are arranged in such a manner that a distance between a part of the first magnetic part on the first recording track at the outermost side of the concentric circles and a part of the third magnetic part on the second recording track at the innermost side of the concentric circles is equal to a distance between a part of the second magnetic part on the first recording track at the outermost side of the concentric circles and the part of the third magnetic part on the second recording track at the innermost side of the concentric circles.

5. The magnetic recording medium according to claim 1, wherein a pitch between a recording track and a recording track adjacent to the recording track is decreased in proportional to an increase of the predetermined angle, and is increased in proportional to a decrease of the predetermined angle.

6. A magnetic recording medium which is rotated by a recording and reproducing apparatus provided with a slider including a recording and reproducing head to record or reproduce a magnetic recording, comprising:
a plurality of recording tracks which is formed concentrically; and
magnetic bands of predetermined width which are formed on the recording tracks, wherein
if the recording and reproducing head which is moved with movement of the slider to record data on or reproduce data from the recording tracks is inclined by a predetermined angle with respect to a tangent line of concentric circles of the recording tracks, the slider being levitated with an aerodynamic force by a predetermined distance from the recording tracks and moving in a radial direction of the concentric circles of the recording tracks,
the predetermined width of the magnetic bands is decreased in proportional to an increase of the predetermined angle, and is increased in proportional to a decrease of the predetermined angle.

7. The magnetic recording medium according to claim 6, wherein a pitch between a recording track and a recording track adjacent to the recording track is decreased in proportional to an increase of the predetermined angle, and is increased in proportional to a decrease of the predetermined angle.

8. A magnetic recording medium on which a plurality of recording tracks is formed concentrically, the plurality of recording tracks including a plurality of magnetic parts which is formed to be symmetrical with respect to an axis in shape, the magnetic recording medium being rotated by a recording and reproducing apparatus provided with a slider including a recording and reproducing head to record or reproduce magnetic recording, comprising:
a substrate;
a soft magnetic film which is formed on the substrate and has a small magnetic resistance;
magnetic films for perpendicular magnetic recording which are formed on the soft magnetic film in a predetermined interval;
heat absorbing films which are formed on the magnetic films; and
non-magnetic films which are formed between the magnetic films and the heat absorbing films.

9. The magnetic recording medium according to claim 8, further comprising a near field light generation film between the substrate and the soft magnetic film.

10. The magnetic recording medium according to claim 8, further comprising a near field light generation film which is formed on a side of the substrate opposite to a side of the substrate on which the soft magnetic film is formed.

11. A magnetic recording medium which is rotated by a recording and reproducing apparatus provided with a slider including a recording and reproducing head to record or reproduce a magnetic recording, comprising:
a plurality of recording tracks which is formed concentrically; and
a plurality of magnetic parts which is formed on the recording tracks and is formed to be symmetrical with respect to an axis in shape, wherein
magnetic films for magnetic recording and a recording film for optical recording are formed on opposite sides of a substrate.

12. A recording and reproducing apparatus which rotates a magnetic recording medium on which a plurality of recording tracks is formed concentrically, the recording tracks including a plurality of fine magnetic parts which are formed to be symmetrical with respect to an axis in shape, comprising:
a slider which is levitated with an aerodynamic force by a predetermined distance from the recording tracks and moves in a radial direction of concentric circles of the recording tracks;
a recording and reproducing head which is provided to the slider and records or reproduces magnetic recording on the magnetic parts formed on the recording tracks;
a tray for storing a flexible sheet like magnetic recording medium;
a cartridge for storing a plurality of the trays;
a moving base for moving the cartridge up and down;
a tray pull-out mechanism for pulling out the tray so as to transfer the magnetic recording medium to a recording and reproducing part;
a magnetic recording and reproducing part moving base which is disposed below the tray pull out mechanism and moves up and down a magnetic recording and reproducing part which records data on or reproduces data from the magnetic recording medium; and
a clamper which is provided above the tray pull out mechanism and fixes the magnetic recording medium to a rotational part of the magnetic recording and reproducing part, the clamper including a float stabilizing disk of which radius is substantially equal to that of the magnetic recording medium, wherein
the rotational part passes through the tray, and the magnetic recording medium is fixed to the rotational part by the clamper when the tray is pulled out from the cartridge.

13. The recording and reproducing apparatus according to claim 12, further comprising a heating part which irradiates a leaser beam to the magnetic recording medium from a side of the clamper, wherein the laser beam passes through the float stabilizing disk to heat the magnetic parts of the magnetic recording medium.

14. The recording and reproducing apparatus according to claim 13, wherein a near light generation film is formed on the float stabilizing disk.

15. The recording and reproducing apparatus according to claim 12, further comprising an optical recording and reproducing part disposed on a side of the clamper that faces to the magnetic recording medium, wherein the recording and reproducing apparatus records data on or reproduces data from both sides of the magnetic recording medium on which magnetic films for magnetic recording and an optical recording film for an optical recording are respectively formed, the magnetic films and the optical recording film sandwiching a substrate of the magnetic recording medium.

16. The recording and reproducing apparatus according to claim 15, wherein a near field light generation film is formed on the float stabilizing disk, and a laser beam emitted from the optical recording and reproducing part irradiates the near field light generation film to generate a near field light to record data on or reproduce data from the recording film for the optical recording provided on the magnetic recording medium.

17. The recording and reproducing apparatus according to claim 12, wherein the magnetic recording and reproducing part is provided on a side of the clamper which faces to the magnetic recording medium, and
the recording and reproducing apparatus records data on or reproduces data from both sides of the magnetic recording medium on which magnetic films for magnetic recording are formed, the magnetic films sandwiching a substrate of the magnetic recording medium.

18. The recording and reproducing apparatus according to claim 12, wherein the rotational part rotates the magnetic recording medium at a speed equal to or more than 10000 rpm.
